(19) United States
(12) Patent Application Publication
(10) Pub. No.: US 2004/0222304 A1
(43) Pub. Date: Nov. 11, 2004

(54) Method and apparatus for on-demand marking or etching of metal

(76) Inventors: Matthew Adams, Fairfield, OH (US); Thomas Rogers, Fairfield, OH (US); Ray Hatfield, Waynesville, OH (US)

Correspondence Address: ORUM & ROTH, 53 W JACKSON BLVD, CHICAGO, IL, 60604-3606, US

(21) Appl. No.: 09/961,740

(22) Filed: Sep. 24, 2001

Related U.S. Application Data
(60) Provisional application No. 60/283,096, filed on Apr. 11, 2001.

(51) Int. Cl. G06K 19/02

(52) U.S. Cl. 235/488

(57) ABSTRACT

An on-demand stencil for marking or etching metal. The stencil comprises a porous medium having a thread count between 150 to 600 threads per inch and a maximum pore size of 0.003 inches. A non-conductive coating material forms a negative image on the porous medium. Etching solution passes through the porous material to an object. Electricity is applied and a positive image is formed on the object. The stencil is formed by obtaining a porous material with a liner on one side and printing on the other side with non-conductive ink to form a negative image.

This application claims the benefit of U.S. Provisional Application No. 60/283,096 filed Apr. 11, 2001.

### BACKGROUND OF THE INVENTION

1. Field of the Invention

The present invention relates to a method and apparatus for on-demand marking or etching of metal. More specifically, the invention relates to on-demand stencils created by depositing a non-conductive coating material on a porous substrate using a printer. The non-conductive coated areas of the stencil are used to selectively block electricity applied to the metal in the presence of an electrochemical etching or marking solution.

2. Description of Related Art

Previously, metal marking utilized batch electrochemical, laser or dotpeen systems that required a large capital investment and suffered from generally limited portability and ease of use.

Direct part marking, for example, in the aerospace industry, is performed by preparing a stencil, attaching the stencil to a component to be marked using adhesive tape and then applying an etching solution. The etching solution passes through the stencil according to the pattern on the stencil and, when electricity is applied via an electrode, marks the component leaving areas masked by the stencil unmarked.

Prior on-demand stencils, for use with direct marking of metal, utilize an opaque coated white mesh material. When the coated mesh material is passed through a printer, a thermal or dot matrix printhead removes the coating in a desired pattern. The printhead thermally removing the coating in the case of a thermal printhead or by knocking out individual points of the coating in the case of a dot matrix type printhead. Both coating removal methods suffering from limited resolution, set by the density of the dot matrix printhead or the localized heating abilities of the thermal type printhead. The pattern of removed material obtained permits the controlled passage of etching solution onto the metal surface to be marked.

The prior forms of on-demand stencils have several drawbacks:

a. The removal of material by the thermal printhead causes a build-up on the printhead requiring printing interruption for cleaning after only a few stencils have been created.

b. As shown in FIG. 1, the mesh material and the coating are both opaque. The lack of contrast makes it very difficult to view the printed pattern created, requiring the pattern to be held up to the light for viewing and increasing the chance that the mark is applied upside down or off center.

c. The print quality of symbols and or text achieved by the current stencil creation process is below customer expectations and is especially unsatisfactory when applied to extremely small components. The limited print quality of the prior stencils resulting from the prior printer's inability to selectively remove areas of the mesh coating in very small portions, thereby limiting the resolution levels achievable.

d. Manually applied, separate, adhesive tape is required to fix the location of the existing on-demand stencil, increasing application time and the opportunity for bleed through of the etching solution if a less than complete taping is performed by the user.

e. Many of the previous mark/etching stencils could be re-used, enabling concealment of component reworking without proper quality control.

It is an object of the present invention to solve these and other problems that will become apparent to one skilled in the art reviewing the following figures, description and claims.

### BRIEF DESCRIPTION OF THE FIGURES

FIG. 1 shows a sample of the prior low contrast film on mesh stencil.

FIG. 2 is a representation of one embodiment of the present invention.

FIG. 3 is a side view of an on-demand stencil showing the various layers thereof.

FIG. 4 is a top view of an on-demand stencil demonstrating use of a print zone free of adhesive and an easy peel-off liner having a narrower width than the stencil material.

FIG. 5 is a diagram of an on-demand stencil system.

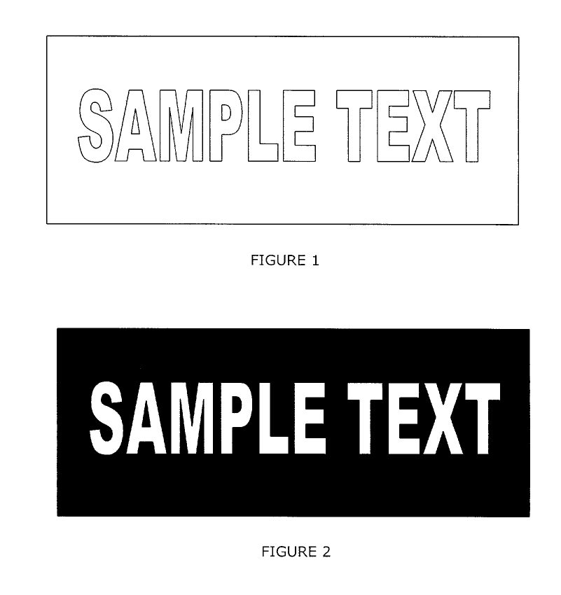

### DETAILED DESCRIPTION

As shown in FIG. 5, a woven or cloth-like fabric, mesh or spunbound porous medium 10 (stencil material) is supplied to a printer 50. The stencil material 10 has a mesh count in the range of 150-600 threads per inch and or a maximum pore or interstice diameter of 0.003 inch. The selection of mesh density or porosity being dependent upon the resolution desired. A high thread count and small pore diameter enabling increased resolution by supporting smaller individual negative areas of the desired image. The printer 50 may be any form of imaging device, for example, thermal, inkjet, bubblejet, laser or hotmelt inkjet. The printer 50 depositing a non-conductive coating material 5, for example, ink, resin, wax, composite or polymer on the desired negative areas of the stencil material 10. To provide a uniform non-conducting surface across all areas not intended to create a mark/etch an increased coat weight of, for example, up to 3.5 times normal is used, thereby sealing the pores and forming a uniform sealing surface. If the stencil material 10 is engineered with a high surface energy, the filling of the pores in the stencil material 10 may be performed at less than 100% sealing. The high surface energy would not allow the mark/etching solution to wet out and flow into any small openings left uncovered.

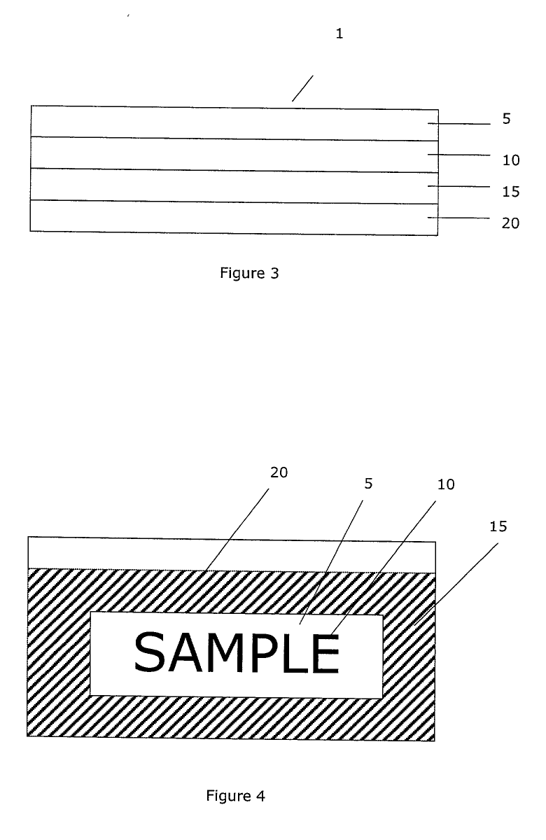

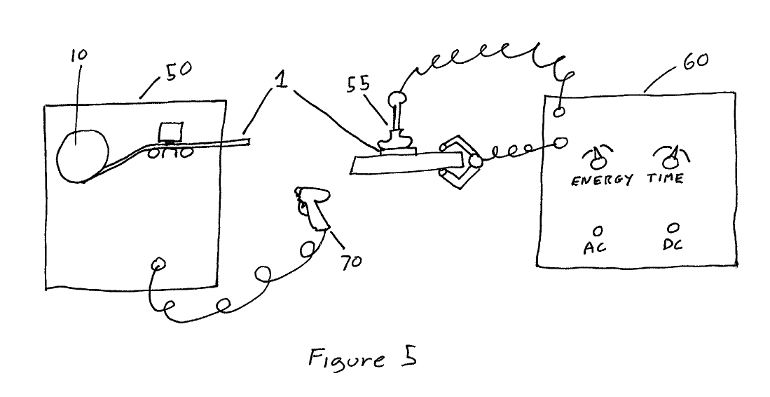

The stencil material 10 surface is porous, permitting mass transport through it, allowing the mark/etching solution to pass through the media that has not been negative printed upon, as shown in FIG. 2, to contact the metal surface. The non-conductive coating material 5 may be provided in a color contrasting the stencil material 10 to provide contrast and easy viewing of the finished stencil without requiring holding the stencil up to the light. In a second embodiment, the stencil material 10 may be provided with an adhesive 15, used to adhere a liner 20 and or adhere the finished stencil 1 to a metal oject to be marked, on the back side or along the backside edges only. The adhesive 15 may have full release and or low residue properties. As shown in FIG. 4, care must be taken to ensure that any adhesive used does not block the stencil material 10 pores in the area desired for image transfer. One method is to define a print area upon which no adhesive 15 is applied. A liner 20 may be provided to support the stencil material 10 as it passes through the printer 50 and or it may be used to cover the adhesive 15 prior to stencil application. A liner 20 that is larger or smaller than the stencil material 10 aids in initiating the peel off of the liner from the stencil material. If desired, the stencil material 10 may be provided in a linerless embodiment, ready for immediate application.

The etching/marking solution is an electrolyte solution containing salts chosen to react with the specific type of metal to be etched/marked. The electricity applied is of a voltage level and duration selected according to the desired result. Voltages in the range of 2 to 20 volts for a period of 2 to 20 seconds results in etches up to 10 mils in depth. If Direct Current (DC) is applied, an etch (metal removal) is made. Alternating Current (AC) creates a dark mark, resulting from the metal being alternately lifted oxidized and then deposited again upon the surface. A deep mark may be created by initially applying a DC voltage to create an etch and then, without moving the stencil, applying an AC voltage to create a mark within the etch.

Heat is generated during voltage application. If the temperature exceeds the heat tolerance of the coating or stencil material the materials begin to break down (melt/liquefy and or burn). Liquid or burned coating material opens the pores in the negative printed area creating a solid mark/etch under the full area of the electrode 55. This characteristic may be used to create a stencil 1 that is usable only once whereby the stencil breaks down from the electric heating present at the end of a first use and any further use would then create only a solid etch/mark under the area of the electrode due to opening of the pores originally sealed by the coating material and or total breakdown of the stencil material 10. Alternatively, a heat resistant coating material such as a UV curable polymer ink may be used with a heat resistant stencil material 10 to create a stencil embodiment that is reusable for multiple stencil applications.

In use, the on-demand stencil is formatted with the desired symbols, and the indicia data sent to a printer to be negative printed. The printer filling all areas of the porous medium not desired to become part of the resulting etch or mark with a coating material. Use of reverse printing for the indicia created, for example, utilizing industry standard software such as BARTENDER or third generation Intermec Programming Language (IPL3) permits the finished stencil to be placed coated side down, creating a better seal against the metal, minimizing leakage of the electrical potential beyond the unprinted area.

The surface to be marked is preferably cleaned to remove any dirt, chemical or oil residue. If the stencil is supplied with a liner, the liner is removed and adhesive for adhering the stencil to the metal surface, if present, exposed. The stencil is then adhered or otherwise affixed to the surface to be marked.

The stencil is coated with either etching or marking solution and an electrode applied to the stencil. Final etch or mark quality is improved if care is taken to eliminate any air bubbles between the surface to be marked and the electrode.

A timed voltage/current is supplied by a power source 60 to the electrode/stencil surface/surface to be marked. The voltage/current level and duration of the voltage/current are selected according to the metal being marked, the type of etching or marking solution used, the thickness of the stencil and desired depth and or desired contrast of the etch/mark.

After the voltage has been applied, the electrode is removed and the stencil peeled off. Leaving a section of the stencil periphery free of adhesive aids in the stencil removal, allowing the user to easily grasp a corner of the stencil to initiate removal by peeling it off.

When the stencil is removed, any remaining etching solution is cleaned from the surface and the finished mark/etching inspected. If a machine readable symbology has been incorporated into the stencil, the stencil and or the finished marking/etching may be verified by scanning the symbology and comparing it to the desired symbology. Where an on demand stencil has been created immediately prior to application, the comparison may be done while the electronic data used to format/print the stencil is still locally available, for example by using a direct or network interconnected scanner 70 and printer 50. Thereby enabling immediate verification of high volume/density data prior to stencil application and or of the finished marked metal that would be difficult or tedious for a human operator to manually compare and or verify.

The present invention is entitled to a range of equivalents and is to be limited only by the following claims.

1. An on-demand stencil for metal marking comprising:
a non-conductive medium having first side and a second side; and
a non-conductive coating material; and
an adhesive;
the coating material printed on the medium forming a negative image on the first side medium;
an unprinted area of porous material corresponds to a desired image
wherein said unprinted area corresponding to the desired image is free of adhesive.

2. The stencil of claim 1, wherein:
a liner is releaseably adhered to the adhesive medium.

3. (Cancelled)

4. (Cancelled)

5. The stencil of claim 1, wherein:
the medium and the coating material have contrasting colors.

6. The stencil of claim 1, wherein:
the medium is a woven mesh with a thread-count greater than 150 threads per inch.

7. The stencil of claim 16, wherein:
the medium has a maximum pore diameter of 0.003 inch.

8. The stencil of claim 1, wherein:
the medium is a spunbound fabric having a maximum interstice diameter of 0.003 inch.

9. The stencil of claim 1, wherein: a coat thickness of the coating material is configured to breakdown upon completion of a single stencil application.

10. The stencil of claim 1, wherein: a coat thickness of the coating material is configured to permit multiple stencil applications prior to breakdown.

11. The stencil of claim 1, wherein: the coating material is a UV curable polymer ink.

12. A system for on-demand metal marking, comprising:
means for on-demand printing of a negative image on a porous medium leaving an unprinted are of porous medium corresponding to a desired image; and
means for electro chemical marking the metal through the unprinted area of the porous medium.

13. The system of claim 12, wherein:
the means for on-demand printing include an imager using one of a non-conductive ink, resin, wax, composite and polymer.

14. The system of claim 12, wherein:
the means for marking is a marking solution, a power supply, and an electrode.

15. A method for on-demand metal marking, comprising the steps of:
printing a negative of an image onto a porous medium, leaving an unprinted area of porous medium corresponding to the image;
placing the medium on the metal;
wetting the metal through the unprinted area of porous medium with a marking solution;
applying an electrode to the medium; and
conducting electricity between the electrode and metal through the unprinted area and the marking solution.

16. The method of claim 15 further including the step of adhering the medium to metal.

17. The method of claim 15, further including the step of cleaning the metal before placing the medium onto the metal.

18. The method of claim 15, further including the step of verifying a machine readable symbol included in the image by comparing a scanned data from the image with an original data used to compose the image.

19. The method of claim 15, wherein the electricity is first direct current and then alternating current.

20. The method of claim 15 wherein:
the negative image is reverse printed.

21. The method of claim 15 wherein:
the medium is placed on the metal with a side of the medium having printing facing the metal.

22. A method for making an on-demand stencil comprising the steps of:
obtaining a porous medium having a liner on a first side:
defining a print area on the medium:
depositing a non-conductive coating material onto a porous medium in the print area to form a negative image whereby an area defining the desired image is uncoated removing the liner from the medium: and
removing any adhesive from the print area.

23. The method of claim 22 further including the step of:
verifying a machine readable section of the stencil by scanning it with a scanner.

24. The stencil of claim 1 wherein the negative image is free of adhesive.

25. The stencil of claim 1 wherein the stencil is free of adhesive.
